(19) United States
(12) Patent Application Publication
(10) Pub. No.: US 2025/0342564 A1
(43) Pub. Date: Nov. 6, 2025

(54) ANALYZING GEOMETRY OF SYNTHETIC SCENES USING EROSION AND DILATION

(71) Applicant: Microsoft Technology Licensing, LLC, Redmond, WA (US)

(72) Inventor: Nicholas BYGRAVE, Manchester (GB)

(73) Assignee: Microsoft Technology Licensing, LLC, Redmond, WA (US)

(21) Appl. No.: 18/653,572

(22) Filed: May 2, 2024

(51) Int. Cl. G06T 5/30; G06T 17/20; G06V 10/25

(52) U.S. Cl. CPC G06T 5/30; G06T 17/20; G06V 10/25

(57) ABSTRACT

The description relates to processing of synthetic scene data. The disclosed implementations can obtain a polygon mesh representing solid structures in a synthetic scene. The polygon mesh can be voxelized and processed to identify zones and portals in the synthetic scene. To identify the zones, a continuous internal space is filled via a flood-filling operation to obtain a filled voxelized representation of the synthetic scene. Then, an erosion process is performed on the filled voxelized representation until distinct disconnected regions are identified. After the disconnected regions are identified, the disconnected regions are dilated by assigning additional voxels to the disconnected regions until distinct zones are identified. Portals are identified where the zones are connected by pairs of filled voxels.

### BACKGROUND

Synthetic scenes are employed in a wide range of applications, such as video games and virtual reality applications. One way to represent a synthetic scene involves employing a polygon mesh, e.g., a set of vertices, edges, and faces representing structures in a given synthetic scene. Polygon meshes are very efficient in terms of computing resource utilization, such as memory and storage. However, there are some characteristics of synthetic scenes that are not adequately represented by polygon meshes.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for processing of synthetic scene data. One example includes a computer-implemented method that can include obtaining a voxelized representation of a synthetic scene. The method can also include performing a flood fill operation on the voxelized representation of the synthetic scene to obtain a flood-filled voxelized representation, the flood-filled voxelized representation having filled voxels representing a continuous internal space in the synthetic scene. The method can also include performing erosion operations on the filled voxels and detecting disconnected regions that become disconnected during the erosion operations until two or more final disconnected regions are identified. The method can also include performing dilation operations to grow the two or more final disconnected regions until two or more zones of the synthetic scene are identified. The method can also include outputting the identified two or more zones.

Another example entails a system comprising a processor and a storage medium storing instructions. When executed by the processor, the instructions can cause the system to obtain a voxelized representation of a synthetic scene. The instructions can also cause the system to perform a flood fill operation on the voxelized representation of the synthetic scene to obtain a flood-filled voxelized representation, the flood-filled voxelized representation having filled voxels representing a continuous internal space in the synthetic scene. The instructions can also cause the system to perform erosion operations on the filled voxels and detecting disconnected regions that become disconnected during the erosion operations until two or more final disconnected regions are identified. The instructions can also cause the system to perform dilation operations to grow the two or more final disconnected regions until two or more zones of the synthetic scene are identified, each identified zone having a set of assigned voxels. The instructions can also cause the system to output the identified two or more zones.

Another example entails a computer-readable storage medium storing instructions which, when executed by a computing device, cause the computing device to perform acts. The acts can include obtaining a voxelized representation of a synthetic scene. The acts can also include performing a flood fill operation on the voxelized representation of the synthetic scene to obtain a flood-filled voxelized representation, the flood-filled voxelized representation having filled voxels representing a continuous internal space in the synthetic scene. The acts can also include performing erosion operations on the filled voxels and detecting disconnected regions that become disconnected during the erosion operations until two or more final disconnected regions are identified. The acts can also include performing dilation operations to grow the two or more final disconnected regions until two or more zones of the synthetic scene are identified. The acts can also include outputting the identified two or more zones.

The above-listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. In some cases, parentheticals are utilized after a reference number to distinguish like elements. Use of the reference number without the associated parenthetical is generic to the element. Further, the left-most numeral of each reference number conveys the FIG. and associated discussion where the reference number is first introduced.

FIG. 1 illustrates an example of a synthetic scene having a building, consistent with some implementations of the present concepts.

FIG. 2 illustrates an example of a voxelized representation of the synthetic scene, consistent with some implementations of the present concepts.

FIG. 3 illustrates an example of a flood-filled voxelized representation of the synthetic scene, consistent with some implementations of the present concepts.

FIGS. 4A and 4B illustrate examples of eroded representations of the synthetic scene, consistent with some implementations of the present concepts.

FIGS. 5A and 5B illustrate examples of a tree having nodes representing the flood-filled voxelized representation and disconnected regions discovered by erosion operations, consistent with some implementations of the present concepts.

FIG. 6 illustrates examples of dilated child nodes, consistent with some implementations of the present concepts.

FIGS. 7A and 7B illustrate examples of voxels assigned to different identified zones, consistent with some implementations of the present concepts.

FIGS. 8A and 8B illustrate examples of portals that connect zones, consistent with some implementations of the present concepts.

FIG. 9 illustrates an example of a sound path from a sound source to a sound destination, consistent with some implementations of the present concepts.

FIG. 10 illustrates an example of a system, consistent with some implementations of the present concepts.

FIG. 11 is a flowchart of an example method, in accordance with some implementations of the present concepts.

### DETAILED DESCRIPTION

### Overview

As noted above, a polygon mesh is a very memory efficient representation of a synthetic scene. However, a polygon mesh representation of a synthetic scene does not directly convey geometric information such as the size and location of zones (such as rooms) in the synthetic scene, or the size and location of portals (such as doors and windows) connecting the zones. Thus, polygon mesh representations can be inadequate for applications that utilize the size and location of zones and portals in a synthetic scene.

As one example, it can be important to know the size and location of zones and portals in a synthetic scene to render realistic sound effects. For instance, the size and locations of zones and portals in a synthetic scene can be employed to determine the shortest path from a sound source in one zone to a sound destination in another zone. Then, the sound can be rendered in a manner that accounts for acoustic properties of the zones and portals that the sound travels through.

One way to address this issue is for synthetic scenes to be marked-up with the location and size of zones and portals in the scene. For instance, a video game developer, artist, or other user can manually identify zones and portals in synthetic scenes using a game engine editor tool. However, this requires significant effort and compliance on the part of the user editing the synthetic scene to diligently and accurately markup each zone and portal as the synthetic scene is modified over time.

The disclosed techniques can overcome these problems by automating the process of identifying zones and portals in a synthetic scene. In the disclosed techniques, a virtual scene is voxelized to create a voxelized representation of the virtual scene. Then, an iterative erosion and dilation process is performed on the voxelized representation to identify the location and size of zones in the scene, such as rooms, as well as portals that connect the zones. The identified zones and portals can then be represented in a polygon mesh and employed for applications such as rendering of realistic sound effects within the virtual scene.

### Terminology

As used herein, the term “synthetic scene” means a digital representation of a space, such as space provided by a video game or virtual reality application. Synthetic scenes can be represented in three dimensions using 3D polygon mesh data or voxels. The term “geometry” refers to occupied space (e.g., solids) in a synthetic scene, such as the ground, walls, ceilings, doors, rocks, trees, hills, etc.

The term “erosion operation” refers to an operation that removes one or more voxels from a region of voxels. For instance, an erosion operation can remove one or more voxels from an outer layer of voxels of a given region. A “region” is any set of connected voxels that occupy a distinct space in a virtual scene. One way to identify a region of connected voxels involves a “flood fill operation” that sets a value for each connected voxel that is not occupied by geometry, until no further connected voxels are identified in a given region. Disconnected regions are regions that have no shared voxels, and are separated from one another by empty voxels. As disconnected regions are eroded by erosion operations, new disconnected regions can be discovered. “Final” disconnected regions are the last disconnected regions discovered by erosion operations, and “intermediate” disconnected regions are disconnected regions discovered before the final disconnected regions. Final disconnected regions can be encompassed by intermediate disconnected regions and can be discovered by splitting the intermediate disconnected regions using erosion operations.

The term “dilation operation” refers to an operation that adds one or more voxels to a region of voxels. For instance, a dilation operation can add one or more voxels to an outer layer of voxels for a given region to obtain dilated regions. Dilation operations can proceed iteratively by adding voxels to “intermediate” dilated regions until a stopping condition is reached, at which point the “final” dilated regions each have a final set of assigned voxels. The set of voxels assigned to each final dilated region can correspond to an identified zone, which be represented in a polygon mesh representation of the synthetic scene.

The term “zone” refers to a region that has been designated as distinct from one or more other zones in a given synthetic scene. For instance, a zone can be a room or hallway in a building with a particular set of acoustic properties. Zones can correspond to the final dilated regions. A “portal” is an area in a given synthetic scene that connects two zones. For instance, a portal can be a doorway, a window, a tunnel, etc., with a defined size and shape through which sound, light, and/or objects can travel at runtime. Portals can be identified by finding seams that connect adjacent zones.

example ALGORITHM

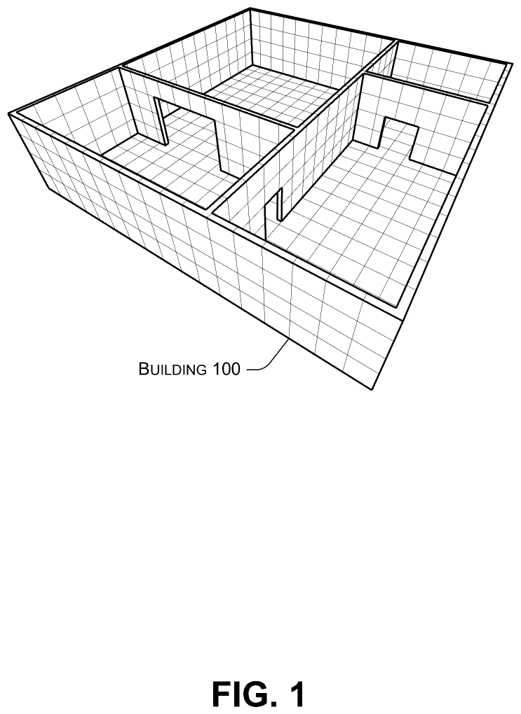

The following describes a specific algorithm that can be employed to discover zones and portals, starting with a polygon mesh representation of a synthetic scene. FIG. 1 illustrates an example of a synthetic scene having a building 100. The building can be represented by a polygon mesh of vertices, edges, and faces that represent the geometry of the synthetic scene, e.g., the walls, floor, and ceiling of the building. Note that the ceiling is not shown in FIG. 1 so that the locations of rooms and doors are visible. While a human can visually discern the location and size of zones (rooms) and portals (doorways) in the building 100, this information is not directly conveyed by the polygon mesh representation. The following algorithm can be employed to analyze the polygon mesh to extract the locations and sizes of the zones and portals.

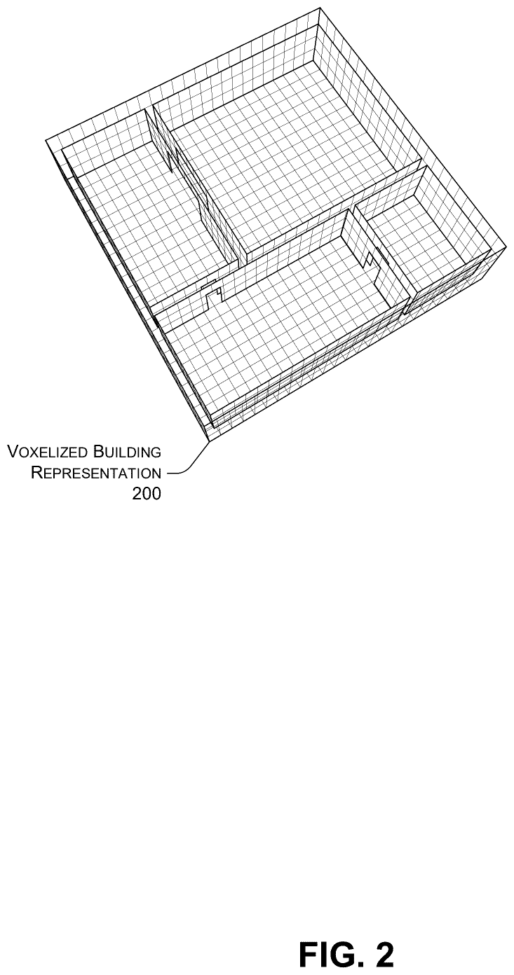

The algorithm starts by identifying a closed volume that represents the boundaries within the synthetic scene to be processed. For instance, user input can designate a boundary around the designated portion of the synthetic scene, and the algorithm can be employed to process the polygon mesh data within that boundary. For the following example, assume that user input has designated a boundary around building 100. First, a voxelization pass is performed on the polygon mesh data within the boundary, e.g., the polygon mesh representing the walls, floor and ceiling of the building. The result is a voxelized building representation 200, shown in FIG. 2. The voxelization quantizes the three-dimensional space containing all of the polygon mesh data to be processed.

The designated area can be quantized into a three-dimensional grid with a specified voxel size (e.g., 10 centimeters). Each voxel can contain a binary value representing whether that voxel is occupied by a solid or by air, e.g., a value of 1 for voxels occupied by solid matter and a value of 0 for empty voxels, e.g., occupied by air. If any primitive in the polygon mesh data intersects the bounds of a given voxel, that voxel is set to 1 representing a voxel filled with a solid. The remaining voxels are left with values of 0, representing empty space. After voxelizing the synthetic scene, the voxels form a simplified representation of the scene geometry, ready for further processing.

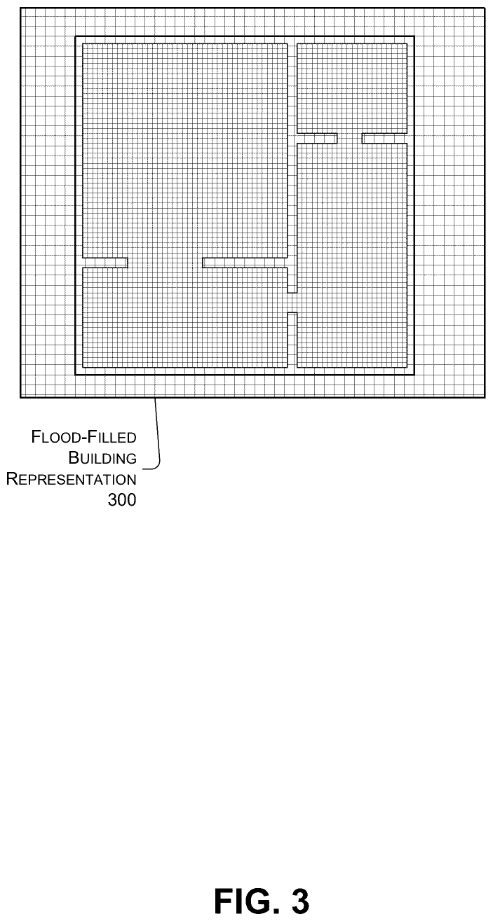

Next, a flood fill operation is performed on the empty space inside the voxelized building representation 200. This step captures the space contained within the building 100 as a new voxel grid by flooding the internal space between the floor, ceiling and walls with voxels. From a given starting point at any empty voxel, all other empty voxels that are connected to that empty voxel or any of its empty connected neighbors can have a value set to 1 indicating that those voxels have been flood-filled. The flood fill operation stops once all connected voxels have either been filled or are adjacent to a solid voxel (e.g., a wall, floor, ceiling, etc.). FIG. 3 shows flood-filled building representation 300, with denser grid areas representing the flood-filled empty space within the building.

Next, repeated erosion operations are performed on flood-filled voxels, where each erosion operation removes a single outer layer of filled voxels. The erosion operations can be performed until there are no flood-filled voxels remaining. During the erosion process, the synthetic scene is split into disconnected regions. Subsequently, repeated dilation operations are performed by adding outer layers of voxels to the disconnected regions. When the dilation operations are completed, the voxels assigned to the final dilated regions are designated as distinct zones in the synthetic scene.

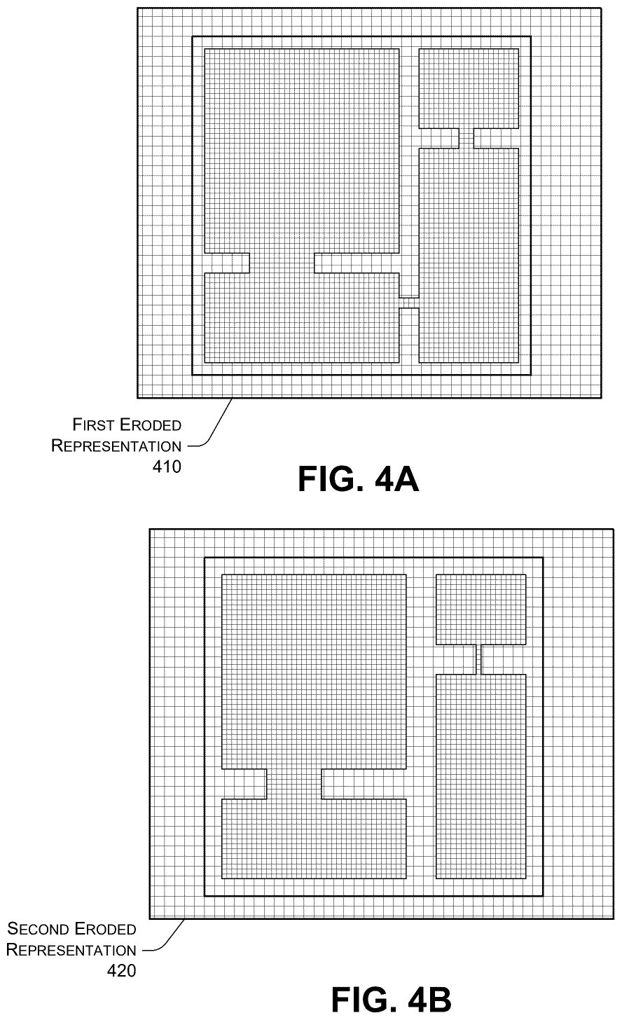

FIG. 4A shows a first eroded representation 410 after one erosion pass on flood-filled building representation 300. As can be seen in FIG. 4A, the denser grid areas representing the flood-filled space are eroded by one voxel, while the less-dense grid areas representing unfilled space have increased in size by one voxel. FIG. 4B shows a second eroded representation 420 after two erosion passes. Here, the denser grid areas representing the flood-filled space have been eroded by two voxels, while the less-dense grid areas representing the unfilled space have increased in size by two voxels.

After each erosion operation, the algorithm analyses the remaining flood-filled space for connectivity. If the remaining flood-filled voxels remain connected as a single region, then another erosion operation is performed. At some point, either the erosion operation splits the remaining flood-filled voxels into disconnected regions, or there are no remaining flood-filled voxels left to erode. One way to analyze the remaining flood-filled space for connectivity involves performing another flood-fill operation on the eroded voxels. If a single flood-fill operation fills all of the remaining eroded voxels, then the remaining voxels are connected. Otherwise, the remaining voxels have split into distinct regions.

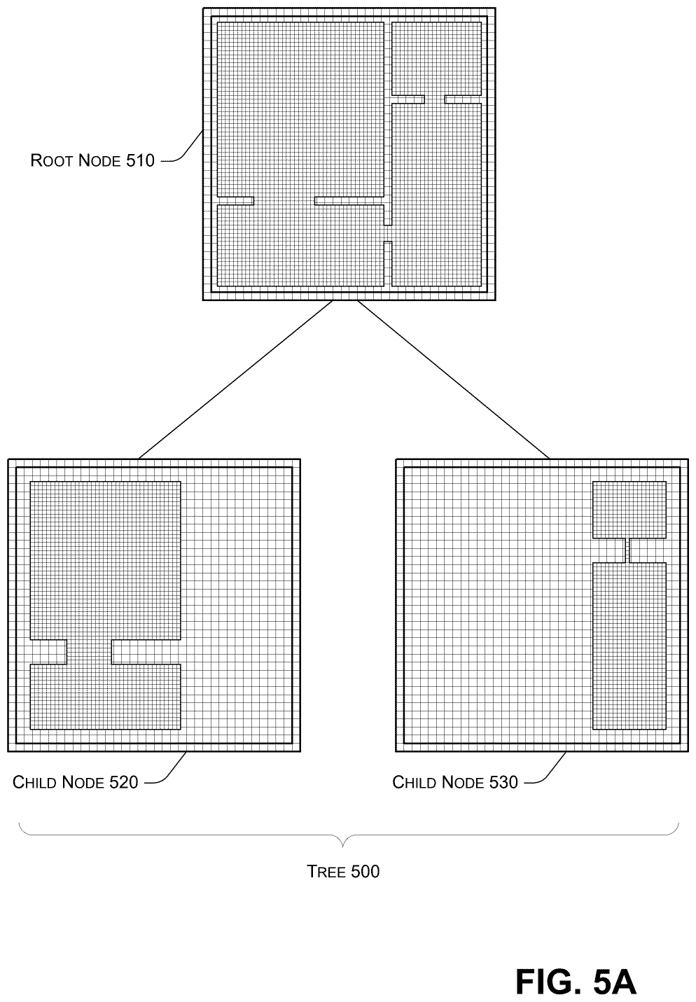

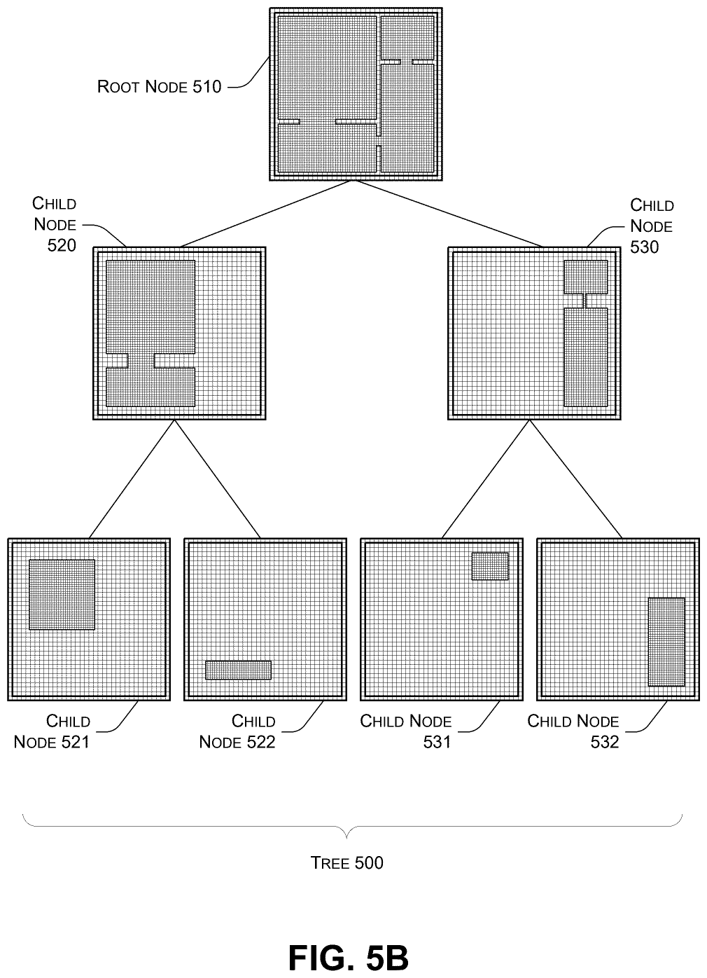

In this case, after two erosion operations, there are now two disconnected regions shown in FIG. 4B. As the erosion operations continue, a tree is built. The root node of the tree represents the result of the initial flood-fill operation, e.g., flood-filled building representation 300. Each time an erosion operation splits a flood-filled region into disconnected regions, child nodes are created representing the newly-discovered disconnected regions. Each child node includes a new voxel grid representing the disconnected regions formed from the most recent erosion operation. The result is shown in FIG. 5A with tree 500 having root node 510, child node 520, and child node 530. Note that root node 510 is identical to the flood-filled building representation 300, while child nodes 520 and 530 each include one of the distinct regions shown in second eroded representation 420.

Next, erosion operations are performed on child node 520 and child node 530. The flood-filled voxels in child node 530 form disconnected regions after a single erosion operation, and the flood-filled voxels in child node 520 form disconnected regions after six erosion passes. Subsequently, tree 500 is modified as shown in FIG. 5B by adding child node 521 and child node 522 as children of child node 520, and child node 531 and 532 as children of child node 530.

The erosion operations and tree modifications can continue until there are no remaining flood-filled voxels in any leaf node of the tree. Each node in the tree contains a snapshot of the voxel erosion state of each disconnected region after the erosion operation that created those regions. For this example, the final state of tree 500 is shown in FIG. 5B. Here, child nodes 520 and 530 represent intermediate disconnected regions. Child node 520 was further eroded to obtain final disconnected regions represented by child nodes 521 and 522, and child node 530 was further eroded to obtain final disconnected regions represented by child nodes 531 and 532.

Given the final state of tree 500, the tree provides a representation of the disconnected regions identified over the entire erosion process. As described more below, the tree provides sufficient information to perform dilation operations to rebuild the original flood-filled voxel grid. Upon completion of the dilation operations, each voxel contained in the original flood fill is now part of a distinct region.

The four leaf child nodes shown in FIG. 5B represent four final disconnected regions identified in flood-filled building representation 300. As can be seen by comparing FIG. 5B to FIG. 3, the final disconnected regions represented in the respective child nodes are much smaller than the corresponding rooms in building 100. The following describes how dilation operations can be performed on each disconnected region, where each dilation operation assigns an outer layer of voxels to the disconnected regions. After the final voxel assignments for each final dilated region are determined, the final dilated regions can be represented by a polygon mesh as respective zones in the synthetic scene.

Each dilation operation starts with a node in tree 500. The voxels of that node and all of its siblings in the tree are dilated in parallel, by adding an outer layer of voxels to the disconnected regions of each node. The voxels are added subject to the condition that the added voxel is part of the space defined by the immediate parent of that node in the tree, and also that the voxel to be added is not already assigned to a sibling node. The dilation operations are repeated until a stopping condition is met where no more voxels can be dilated in any of the nodes. This stopping condition indicates that the set voxels in the parent are also assigned to one and only one of its children.

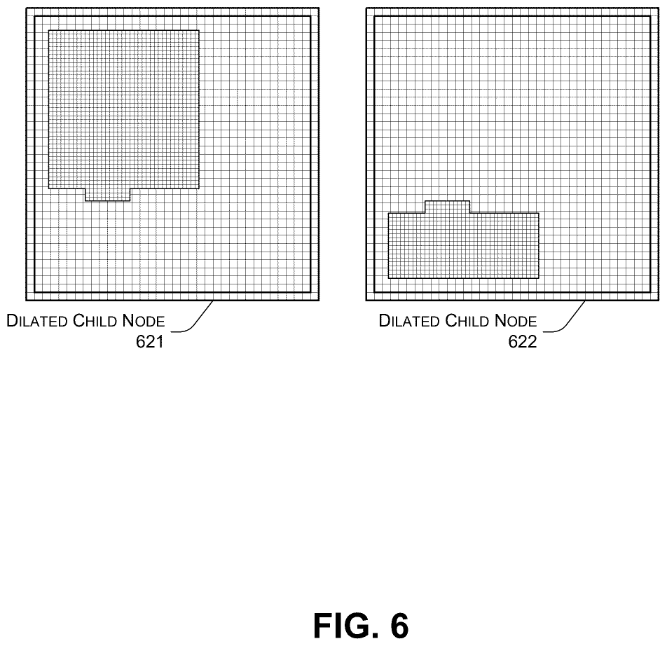

Once the dilation of each node is complete, the process moves up the tree to do the dilation operations again on the nodes in the next layer up in the tree. Note that the dilation of the parent can add voxels to the parent node. As a consequence, this can change the dilation conditions for the children of the dilated parent node. Thus, after at least one voxel is added to any node by a dilation operation, the children of that node are reset back to a “needs dilation” state and the process continues up the tree to the root node, with successive re-dilations of nodes further down the tree using their updated parent data. This ensures that the full dilation of each node is informed by the erosion process at each junction and branch in the tree. When no more nodes in the tree need dilating, the process is complete. After final dilation, child node 521 appears as dilated child node 621 and child node 522 appears as dilated child node 622, which are shown in FIG. 6.

Note that each child node of a given parent node is assigned a discrete subset of the set of voxels assigned to the parent node. Said another way, the assigned voxels of the parent node encompass all of the assigned voxels of each child node, and the child nodes do not share any voxels. By building the tree using iterative erosion and splitting operations as described previously, the nodes of the tree carry structural information that conveys the discovered structural relationships between the child nodes and the parent nodes. During dilation, the structural relationships conveyed by the structure of the tree ensure that the growth of each child node via the dilation operations is constrained by the voxels assigned to the parent node. As a consequence, the voxels assigned to the final dilated regions accurately encompass distinct zones of the synthetic scene.

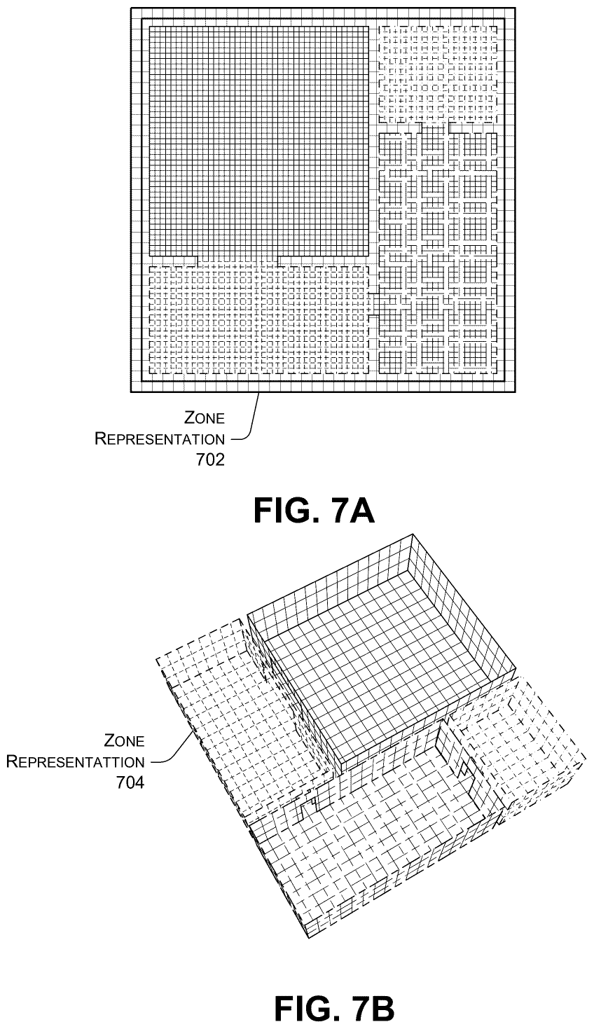

Overlaying the fully dilated leaf nodes produces a voxel grid with “zones” of voxel assignments. FIG. 7A shows zone representation 702 as a top-down view of the discovered zones, and FIG. 7B shows zone representation 704 as a perspective view of the discovered zones. Note that different line patterns are used to represent the different zone assignments in FIGS. 7A and 7B. The discovered zones accurately reflect what a human being would recognize as four different rooms in building 100.

Once the zones have been identified, some implementations can use the voxelized representation of the partitioned space to identify and transform the distinct zones from the voxel regions into a polygon mesh representation. This process can also use the information at the seams between these zones to identify where portals exist between the zones. This data can also then be transformed into a more useful polygon mesh representation.

There are different approaches that can be employed to extract polygon mesh data for zones and portals from the voxelized representation. For the zones, the spaces can be approximated with a 3D polygon mesh volume. There are many ways to achieve this using voxel data, and the quality of the results can be improved by also including the original scene 3D data in the process.

If only the voxel data is used, the process can start by approximating the containing volume by dilating the region so that the outer voxels now intersect with the regions 3D mesh volume. This is an approximation that helps to ensure the identified zones contain all of the voxels of the fully dilated regions, but produces reasonable accurate results. Alternatively, a full 3D mesh could be obtained using a marching cubes algorithm on the voxels, followed by a mesh simplification to reduce the number of polygons in the mesh.

The following describes one approach, which involves generating a pseudo-2.5D extruded shape volume. This assumes a fixed height floor and ceiling and defines a 2D shape on the floor/ceiling plane that, when extruded vertically, contains all the region's voxels. This simpler shape can reduce the cost of any real-time processing that uses the data.

Various approaches can be used to identify portals. Generally, portals can be identified by finding voxels assigned to one zone that are adjacent to voxels assigned to another zone. After each “air” voxel has been assigned to one (and only one) zone, any two adjacent voxels assigned to different zones can be designated as part of a portal between those two zones. Note that there may be multiple portals that connect two zones, so pairs of adjacent voxels assigned to different zones can be grouped into collections of pairs, where each collection represents a different portal.

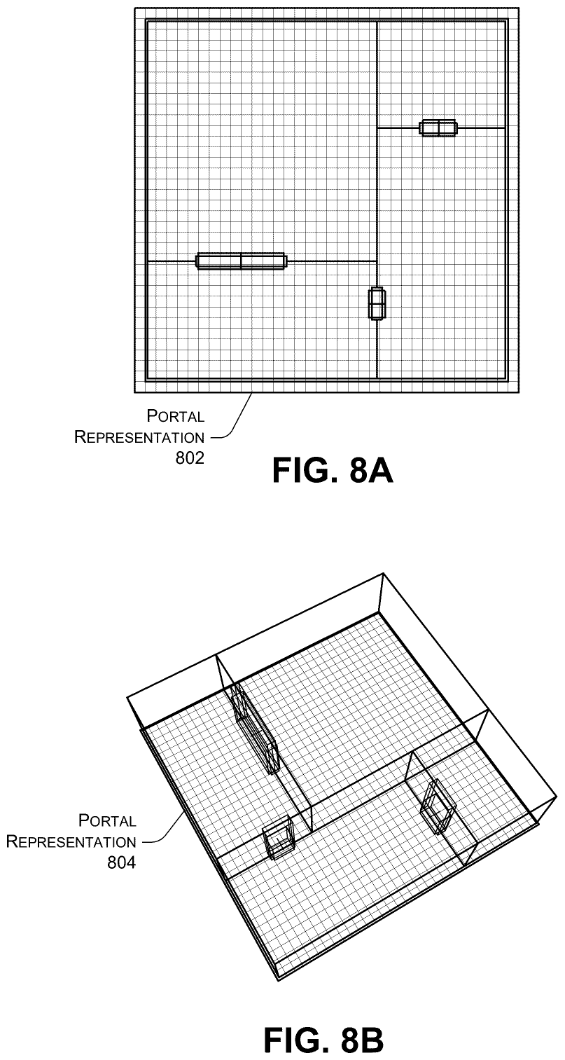

One way to create oriented portals from this data is as follows. For each collection of connected pairs of voxels assigned to different zones, that connected pair is part of a portal. The orientation of that portal can be approximated by taking the average direction of the voxel pairs that are part of their portal, summing all of their orthogonal direction vectors, and normalizing the result. The result is a vector that indicates the orientation of that portal. Using that vector, the smallest oriented bounding box that contains all the voxel pairs for that portal can be calculated. This generates an oriented bounding box volume that encloses the portal shape and size. FIG. 8A shows portal representation 802 as a top-down view of the discovered portals, and FIG. 8B shows portal representation 804 as a perspective view of the discovered portals. Heavier line weights are used in FIGS. 8A and 8B to convey the discovered portals.

### Further Implementations

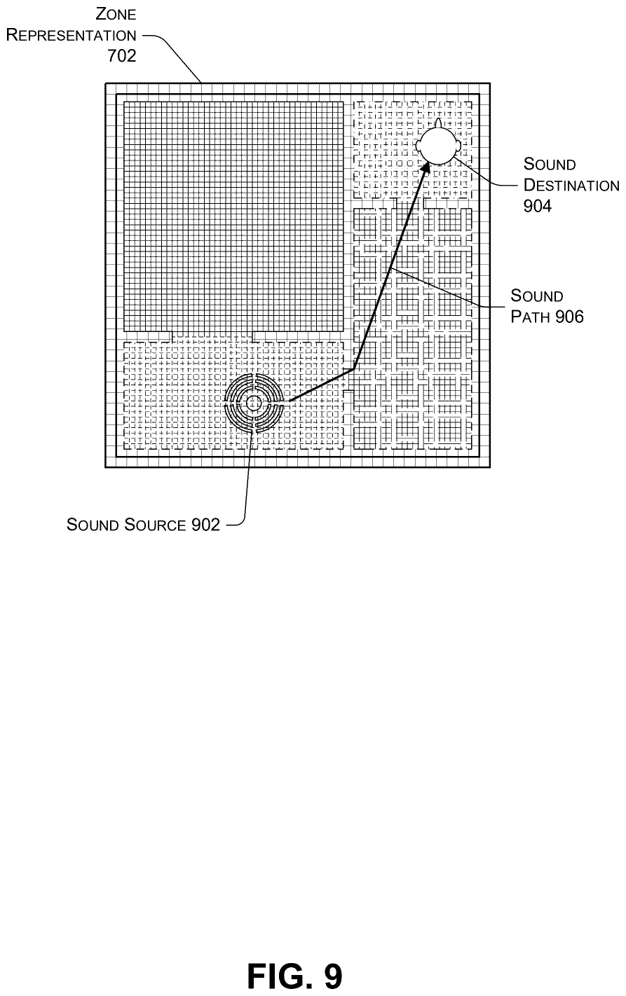

The disclosed techniques can be performed for a wide range of applications and use cases. For instance, some implementations can use the identified zones and portals for sound rendering. Consider FIG. 9, which shows a sound source 902 and a sound destination 904. A sound path 906 from the sound source to the sound destination travels through three zones via two portals. This sound path is the shortest path from the sound source to the sound destination. The sound can be rendered and attenuated based on the extent to which the portals along the path are opened or closed, e.g., according to a designated transmissivity value. In some cases, additional sound paths can also be identified and properties of those additional paths can be blended to produce realistic sounds that account for acoustic properties of each zone and/or portal through which sound travels from the sound source to the sound destination.

As another example, consider an architectural model of a scene that is provided as a polygon mesh. The disclosed techniques could be performed to identify zones and portals in the architectural model. This can be performed on an iterative basis as updates are made to the architectural model.

Furthermore, the disclosed techniques can be utilized for path analysis in a synthetic scene. For instance, the disclosed techniques can be utilized to determine the shortest path between any two points in a synthetic scene. In some cases, the shortest path can vary depending on the size of the object that is travelling, e.g., the portals on the path may meet a size constraint for the size of a traveling object. For instance, the size of each portal can be estimated based on the number of voxels occupied by that portal. In some cases, an object may be too large to pass through one or more portals, in which case the shortest path for larger objects may be different than for shorter objects.

In addition, the disclosed techniques may also be performed for graphics rendering. For instance, light propagation within a synthetic scene can be modeled by determining the path that light travels from a light source to a light destination via individual portals. Furthermore, shading algorithms can be applied to model the extent to which partially-closed portals obstruct light travel between the light source and the light destination.

Note that the disclosed implementations can be employed iteratively as changes are made to a synthetic scene. For instance, consider a server-based video game with multiple distributed users that play the game on respective client devices connected to a server. The video game may provide the same synthetic scene to each client device, e.g., the users can play interactively within the synthetic scene.

In some cases, users may also be provided with a scene editor that allows users to make changes to the synthetic scene. For instance, one user may add a building to the synthetic scene, and then that building will be visible to all of the other players of the game. Depending on the number of users editing the synthetic scene and the extent of the changes, this can result in very rapid changes to the synthetic scene.

The disclosed techniques can be employed each time a change is made to the synthetic scene to update any zones or portals that may have been added by a user. For instance, assume a user adds a portal between two zones—in other words, the user modification causes voxels representing solid space to change to voxels representing air. The portal can be readily discovered by analyzing the changed voxels and determining which zones they are assigned to, updating the voxelized representation of the synthetic scene to identify the new portal.

Likewise, consider a scenario where a user adds one or more walls within a zone to create two new zones. The new zones can be discovered efficiently by starting from the leaf node representing the existing zone to which the new zones are added. The erosion and dilation operations described above can be performed to generate a new subtree of that particular leaf node, without modifying the remainder of the tree. As a consequence, the disclosed implementations can efficiently handle frequent modifications to a synthetic scene without starting from scratch each time a new zone or portal is added.

### Example System

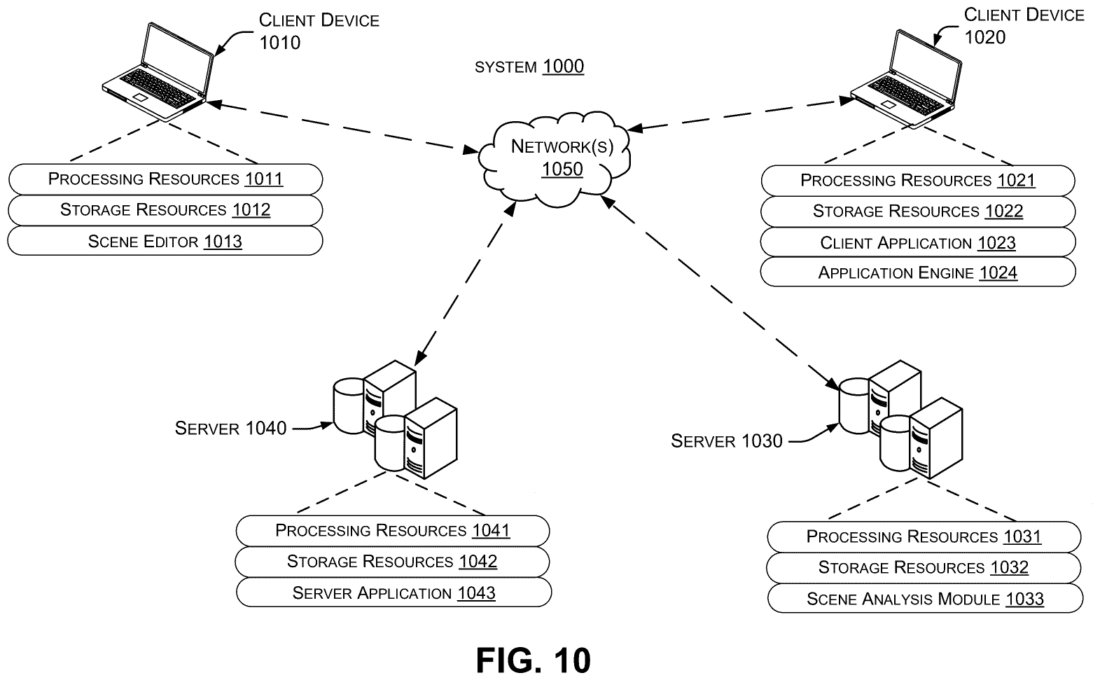

The present implementations can be performed in various scenarios on various devices. FIG. 10 shows an example system 1000 in which the present implementations can be employed, as discussed more below.

As shown in FIG. 10, system 1000 includes a client device 1010, a client device 1020, a server 1030, and a server 1040, connected by one or more network(s) 1050. Note that the client device can be embodied both as a mobile device such as smart phones or tablets, as well as stationary devices such as desktops, server devices, etc. Likewise, the servers can be implemented using various types of computing devices. In some cases, any of the devices shown in FIG. 10, but particularly the servers, can be implemented in data centers, server farms, etc.

Client device 1010 can have processing resources 1011 and storage resources 1012, client device 1020 can have processing resources 1021 and storage resources 1022, server 1030 can have processing resources 1031 and storage resources 1032, and server 1040 can have processing resources 1041 and storage resources 1042. The devices of system 1000 may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 1010 can include a scene editor 1013. The scene editor can allow a user of the client device to create and/or modify a synthetic scene associated with an application, such as a video game or a virtual reality application. For instance, the scene editor can allow the user to add new buildings, mountains, trees, roads, furniture, rocks, or other solid structures to the synthetic scene. As a result of edits to the synthetic scene, new zones and/or portals can be created. The scene editor can also allow the user to select an area within the synthetic scene to be processed as described herein for identification of zones and/or portals.

Client device 1020 can have a client application 1023 and an application engine 1024. For example, the client application can be a video game and/or virtual reality application that uses the synthetic scene generated by the scene editor 1013 on client device 1010. The application engine can provide functionality such as audio rendering, graphics rendering, or physics simulations that can be used by the client application.

Server 1030 can include a scene analysis module 1033 that processes the scene generated by the scene editor 1013 on client device 1010. For instance, the scene editor can employ the algorithm described above to identify zones and portals in the scene. The scene analysis module can maintain a tree structure as described previously. Each time a change is made to the synthetic scene, the tree structure can be updated to reflect any newly-discovered zones and/or portals.

Server 1040 can include a server application 1043. For instance, if client application 1023 is a multiplayer video game, the server application can coordinate gameplay among multiple different client devices by receiving inputs from the client devices and sending game outputs to the client devices. The server application can also receive the identified zones and portals from server 1030 and provide them to the client application on client device 1020 or other client devices.

The client application 1023 can use the identified zones and/or portals for various purposes. For instance, as described previously, runtime sound effects can be rendered by accounting for acoustic properties of zones and portals between sound sources and sound destinations. In other implementations, graphics rendering can be performed in a manner that accounts for the zones and/or portals through which light travels from a light source to a light destination. In addition, path analysis can be used to inform whether objects (such as characters or vehicles) can travel from one zone to another while fitting through portal(s) connecting the zones.

### Example Method

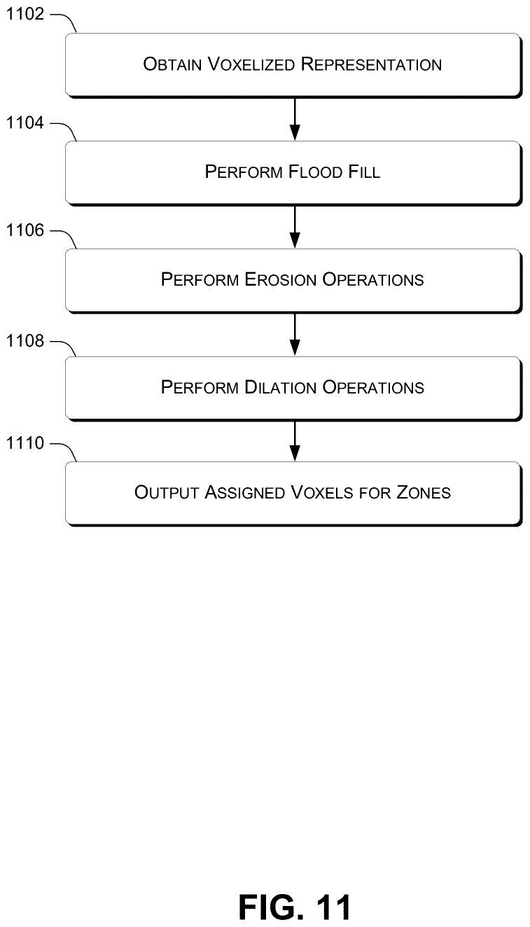

FIG. 11 illustrates an example computer-implemented method 1100, consistent with some implementations of the present concepts. Method 1100 can be implemented on many different types of devices, e.g., by one or more cloud servers, by a client device such as a laptop, tablet, or smartphone, or by combinations of one or more servers, client devices, etc.

Method 1100 begins at block 1102, where a voxelized representation of a synthetic scene is obtained. For instance, the synthetic scene can be represented as a polygon mesh and converted into a voxelized representation with each voxel having a bit representing whether that voxel is occupied by solid matter or air. The synthetic scene can be part of a video game, architectural model, virtual and/or augmented reality application, etc. In some cases, block 1102 can involve receiving user input specifying a boundary within the synthetic scene for further processing, and the voxelized representation can be created for the area in the synthetic scene defined by that boundary. User input can also be employed to specify a voxel size for the voxelization.

Method 1100 continues at block 1104, where a flood fill operation is performed on the voxelized representation to obtain a flood-filled voxelized representation of the synthetic scene. The flood-filled voxelized representation can have filled voxels representing a continuous internal space within the synthetic scene. For instance, as described above, the continuous internal space can be the inside of a building.

Method 1100 continues at block 1106, where erosion operations are performed while disconnected regions are detected. For instance, as described above, the erosion operations can remove layers of filled voxels until the filled areas split into disconnected regions. Each disconnected region can be represented as a node in a tree and can be further eroded to identify new disconnected regions until no more filled voxels remain. The final disconnected regions can be represented as leaf nodes in the tree, with intermediate disconnected regions being represented as internal nodes in the tree.

Method 1100 continues at block 1108, where dilation operations are performed to grow the final disconnected regions until zones are identified. Each dilation operation can add voxels to the final disconnected regions while traveling up the tree to obtain information from parent nodes. Once each final disconnected region has been fully dilated, all the voxels assigned to each respective disconnected region correspond to an individual zone of the synthetic scene.

Method 1100 continues at block 1110, where the identified zones are output. For instance, the voxel assignments of the final dilated regions can be employed to determine the location and size of each zone in a polygon mesh representation of the synthetic scene, e.g., an automated markup of the previously-received polygon mesh. In addition, the voxel assignments can be employed for identifying portals in the synthetic scene, and the polygon mesh can be automatically marked up with the locations and sizes of the portals. Subsequently, the zones and/or portals can be employed at runtime for acoustic or graphics rendering, path analysis, etc.

### Technical Effect

The disclosed implementations offer a very lightweight, efficient approach for identifying zones and portals in synthetic scenes. As noted previously, one alternative is for synthetic scenes to be marked-up with the location and size of zones and portals in the synthetic scene. While this is a realistic expectation for professionals, such as video game developers or artists, it is not realistic to expect most end users to reliably mark up zones and portals when editing a synthetic scene. Thus, manual markup techniques do not scale well when scene editing capabilities are broadly available to end users.

The disclosed implementations are also very useful for acoustic rendering scenarios. One way to render realistic sound in a synthetic scene involves performing expensive simulations of sound travel in the scene. Then, data can be stored that indicates sound parameters such as loudness or directionality of sound between any two locations in the scene. However, when end users are performing frequent changes to a synthetic scene, it is not realistic to perform updated simulations for every change to the synthetic scene.

The disclosed implementations can efficiently capture changes to zones and portals in a synthetic scene even when end users are rapidly making changes to the synthetic scene. Given knowledge as to the size and location of zones and portals in the synthetic scene, sound can be realistically rendered at runtime without needing to perform acoustic simulations as described previously. Rather, the zones and portals discovered as described herein can be employed to determine sound paths from sound sources to sound destinations. Then, the loudness and directionality of sound can be manipulated to achieve realistic effects. In addition, the sound can be modified to take on acoustic characteristics (e.g., reverberation qualities) based on the size and shape of zones that the sound path(s) travel through.

### Device Implementations

As noted above with respect to FIG. 10, system 1000 includes several devices, including a client device 1010, a client device 1020, a server 1030, and a server 1040. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the terms “computer-readable medium” and “computer-readable media” can include signals. In contrast, the terms “computer-readable storage medium” and “computer-readable storage media” exclude signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 1050. Without limitation, network(s) 1050 can include one or more local area networks (LANs), wide area networks (WANs), the Internet, and the like.

### Additional Examples

Various examples are described above. Additional examples are described below. One example includes a method comprising obtaining a voxelized representation of a synthetic scene, performing a flood fill operation on the voxelized representation of the synthetic scene to obtain a flood-filled voxelized representation, the flood-filled voxelized representation having filled voxels representing a continuous internal space in the synthetic scene, performing erosion operations on the filled voxels and detecting disconnected regions that become disconnected during the erosion operations until two or more final disconnected regions are identified, performing dilation operations to grow the two or more final disconnected regions until two or more zones of the synthetic scene are identified, and outputting the identified two or more zones.

Another example can include any of the above and/or below examples where the method further comprises building a tree having a root node representing the flood-filled voxelized representation, the tree having leaf nodes representing the two or more final disconnected regions.

Another example can include any of the above and/or below examples where the method further comprises representing intermediate disconnected regions detected via the erosion operations as internal nodes of the tree.

Another example can include any of the above and/or below examples where the method further comprises performing the erosion operations on the intermediate disconnected regions until the intermediate disconnected regions split into the two or more final disconnected regions.

Another example can include any of the above and/or below examples where the method further comprises discovering respective disconnected regions using further flood fill operations.

Another example can include any of the above and/or below examples where the method further comprises performing the erosion operations and the further flood fill operations until no remaining filled voxels are left to erode.

Another example can include any of the above and/or below examples where the method further comprises iteratively dilating respective disconnected regions starting from the leaf nodes and moving up the tree toward the root node.

Another example can include any of the above and/or below examples where the method further comprises assigning particular voxels to a particular disconnected region when the particular voxels are assigned to an immediate parent of the particular disconnected region and not already assigned to a sibling of the particular disconnected region.

Another example can include any of the above and/or below examples where the method further comprises continually re-dilating individual disconnected regions using updated parent node data until each disconnected region is fully dilated into a final dilated region, each final dilated region corresponding to an individual zone.

Another example can include any of the above and/or below examples where the method further comprises representing the identified two or more zones in a polygon mesh representation of the synthetic scene.

Another example can include any of the above and/or below examples where the method further comprises identifying pairs of connected voxels that connect different zones and based at least on the pairs of connected voxels, identifying portals in the synthetic scene and representing sizes and locations of the portals in the polygon mesh representation.

Another example can include any of the above and/or below examples where the method further comprises determining respective orientations of the portals and generating oriented bounding boxes for each of the portals, the oriented bounding boxes encompassing respective pairs of connected voxels.

Another example includes a system comprising a processor and storage storing computer-readable instructions which, when executed by the processor, cause the processor to obtain a voxelized representation of a synthetic scene, perform a flood fill operation on the voxelized representation of the synthetic scene to obtain a flood-filled voxelized representation, the flood-filled voxelized representation having filled voxels representing a continuous internal space in the synthetic scene, perform erosion operations on the filled voxels and detecting disconnected regions that become disconnected during the erosion operations until two or more final disconnected regions are identified, perform dilation operations to grow the two or more final disconnected regions until two or more zones of the synthetic scene are identified, each identified zone having a set of assigned voxels, and output the identified two or more zones.

Another example can include any of the above and/or below examples where the instructions, when executed by the processor, cause the processor to receive input specifying a boundary within the synthetic scene and obtain the voxelized representation within the boundary.

Another example can include any of the above and/or below examples where the instructions, when executed by the processor, cause the processor to receive input specifying a voxel size and generate the voxelized representation having the specified voxel size.

Another example can include any of the above and/or below examples where the instructions, when executed by the processor, cause the processor to receive an updated synthetic scene having additional geometry and perform further fill, erosion, and dilation operations on a further voxelized representation of the updated synthetic scene to identify further zones in the updated synthetic scene.

Another example can include any of the above and/or below examples where the instructions, when executed by the processor, cause the processor to identify portals between adjacent zones.

Another example can include any of the above and/or below examples where the instructions, when executed by the processor, cause the processor to render sound in the synthetic scene accounting for acoustic properties of zones and portals along a path from a sound source to a sound destination.

Another example can include any of the above and/or below examples where the instructions, when executed by the processor, cause the processor to find a shortest path between two locations in the synthetic scene for an object having a particular size, the shortest path having portals meeting a size constraint for the particular size of the object.

Another example includes a computer-readable storage medium storing instructions which, when executed by a computing device, cause the computing device to perform acts comprising obtaining a voxelized representation of a synthetic scene, performing a flood fill operation on the voxelized representation of the synthetic scene to obtain a flood-filled voxelized representation, the flood-filled voxelized representation having filled voxels representing a continuous internal space in the synthetic scene, performing erosion operations on the filled voxels and detecting disconnected regions that become disconnected during the erosion operations until two or more final disconnected regions are identified, performing dilation operations to grow the two or more final disconnected regions until two or more zones of the synthetic scene are identified, and outputting the identified two or more zones.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method, comprising:
obtaining a voxelized representation of a synthetic scene;
performing a flood fill operation on the voxelized representation of the synthetic scene to obtain a flood-filled voxelized representation, the flood-filled voxelized representation having filled voxels representing a continuous internal space in the synthetic scene;
performing erosion operations on the filled voxels and detecting disconnected regions that become disconnected during the erosion operations until two or more final disconnected regions are identified;
performing dilation operations to grow the two or more final disconnected regions until two or more zones of the synthetic scene are identified; and
outputting the identified two or more zones.

2. The method of claim 1, further comprising:
building a tree having a root node representing the flood-filled voxelized representation, the tree having leaf nodes representing the two or more final disconnected regions.

3. The method of claim 2, further comprising:
representing intermediate disconnected regions detected via the erosion operations as internal nodes of the tree.

4. The method of claim 3, further comprising:
performing the erosion operations on the intermediate disconnected regions until the intermediate disconnected regions split into the two or more final disconnected regions.

5. The method of claim 4, further comprising:
discovering respective disconnected regions using further flood fill operations.

6. The method of claim 5, further comprising:
performing the erosion operations and the further flood fill operations until no remaining filled voxels are left to erode.

7. The method of claim 6, further comprising:
iteratively dilating respective disconnected regions starting from the leaf nodes and moving up the tree toward the root node.

8. The method of claim 7, further comprising:
assigning particular voxels to a particular disconnected region when the particular voxels are assigned to an immediate parent of the particular disconnected region and not already assigned to a sibling of the particular disconnected region.

9. The method of claim 8, further comprising:
continually re-dilating individual disconnected regions using updated parent node data until each disconnected region is fully dilated into a final dilated region, each final dilated region corresponding to an individual zone.

10. The method of claim 1, further comprising:
representing the identified two or more zones in a polygon mesh representation of the synthetic scene.

11. The method of claim 10, further comprising:
identifying pairs of connected voxels that connect different zones; and
based at least on the pairs of connected voxels, identifying portals in the synthetic scene and representing sizes and locations of the portals in the polygon mesh representation.

12. The method of claim 11, further comprising:
determining respective orientations of the portals; and
generating oriented bounding boxes for each of the portals, the oriented bounding boxes encompassing respective pairs of connected voxels.

13. A system comprising:
a processor; and
storage storing computer-readable instructions which, when executed by the processor, cause the processor to:
obtain a voxelized representation of a synthetic scene;
perform a flood fill operation on the voxelized representation of the synthetic scene to obtain a flood-filled voxelized representation, the flood-filled voxelized representation having filled voxels representing a continuous internal space in the synthetic scene;
perform erosion operations on the filled voxels and detecting disconnected regions that become disconnected during the erosion operations until two or more final disconnected regions are identified;
perform dilation operations to grow the two or more final disconnected regions until two or more zones of the synthetic scene are identified, each identified zone having a set of assigned voxels; and
output the identified two or more zones.

14. The system of claim 13, wherein the instructions, when executed by the processor, cause the processor to:
receive input specifying a boundary within the synthetic scene; and
obtain the voxelized representation within the boundary.

15. The system of claim 13, wherein the instructions, when executed by the processor, cause the processor to:
receive input specifying a voxel size; and
generate the voxelized representation having the specified voxel size.

16. The system of claim 13, wherein the instructions, when executed by the processor, cause the processor to:
receive an updated synthetic scene having additional geometry; and
perform further fill, erosion, and dilation operations on a further voxelized representation of the updated synthetic scene to identify further zones in the updated synthetic scene.

17. The system of claim 13, wherein the instructions, when executed by the processor, cause the processor to:
identify portals between adjacent zones.

18. The system of claim 17, wherein the instructions, when executed by the processor, cause the processor to:
render sound in the synthetic scene accounting for acoustic properties of zones and portals along a path from a sound source to a sound destination.

19. The system of claim 17, wherein the instructions, when executed by the processor, cause the processor to:
find a shortest path between two locations in the synthetic scene for an object having a particular size,
the shortest path having portals meeting a size constraint for the particular size of the object.

20. A computer-readable storage medium storing instructions which, when executed by a computing device, cause the computing device to perform acts comprising:
obtaining a voxelized representation of a synthetic scene;
performing a flood fill operation on the voxelized representation of the synthetic scene to obtain a flood-filled voxelized representation, the flood-filled voxelized representation having filled voxels representing a continuous internal space in the synthetic scene;
performing erosion operations on the filled voxels and detecting disconnected regions that become disconnected during the erosion operations until two or more final disconnected regions are identified;
performing dilation operations to grow the two or more final disconnected regions until two or more zones of the synthetic scene are identified; and
outputting the identified two or more zones.
